(19) United States
(12) Patent Application Publication
(10) Pub. No.: US 2026/0336499 A1
(43) Pub. Date: Oct. 29, 2026

(54) Methods and Systems for Controlling Operations of Movable Vehicle-Mounted Structures Using Sensors

(71) Applicant: Harbinger Motors Inc., Garden Grove, CA (US)

(72) Inventors: Jongmoo Choi, Garden Grove, CA (US); Dheemanth Uppalapati, Garden Grove, CA (US); Phillip John Weicker, Redondo Beach, CA (US); Richard Walker, Garden Grove, CA (US); Isaac Meadows, Garden Grove, CA (US); Murphy Stratton, Garden Grove, CA (US)

(21) Appl. No.: 19/659,626

(22) Filed: Apr. 27, 2026

Related U.S. Application Data
(60) Provisional application No. 63/794,925, filed on Apr. 25, 2025.

(51) Int. Cl. B60P 1/44; B62D 33/027; B62D 33/03

(52) U.S. Cl. CPC B60P 1/4478; B60P 1/4464; B62D 33/0276; B62D 33/03

(57) ABSTRACT

Described herein are methods and systems for safe and efficient deployment of a movable vehicle-mounted structure on a truck. An advanced driving controller unit (ADCU) may receive a structure deployment request and obtain spatial information for a structure zone using one or more vehicle sensors, such as cameras, LiDAR, radar, or proximity sensors. The ADCU may analyze the spatial information to evaluate one or more criteria, including object presence, occupancy, free-space, collision risk, or intrusion, and may permit deployment when safe conditions are determined. Sensor data may be processed from single or multiple images, multiple views, and/or other sensing modalities, and may be transformed into a common coordinate frame based on preconfigured, updated, or automatically estimated calibration. Monitoring may continue during deployment. In some examples, the ADCU immobilizes the truck during deployment and, after deployment, evaluates a structure travel zone to support safe vehicle movement.

### CROSS-REFERENCE TO RELATED APPLICATIONS

This application claims the benefit under 35 U.S.C. § 119(e) of US Provisional Patent Application 63/794,925, filed on Apr. 25, 2025, which is incorporated herein by reference in its entirety for all purposes.

### BACKGROUND

Movable vehicle-mounted structures, such as liftgates, ramps, steps, doors, hatches, platforms, carriers, ladders, and access panels, may be hydraulically, electrically, pneumatically, and/or mechanically actuated on trucks, trailers, and other vehicles. These structures may facilitate loading, unloading, access, transport, servicing, and other vehicle operations. In many implementations, such structures move through or into regions adjacent to the vehicle and may occupy a defined footprint, swept area, or travel zone during deployment, retraction, or use.

However, deployment and operation of movable vehicle-mounted structures may present safety concerns. For example, a structure operator may need to ensure that people, animals, cargo, fixed obstacles, and other objects are not present in a structure zone associated with the deployed structure or its motion path. In many vehicles, actuation controls are positioned near the structure itself, requiring the operator to leave the cabin and visually monitor the relevant area during operation, which may be inefficient and may not provide reliable awareness of all potentially affected regions. In addition, existing control arrangements may not be integrated with vehicle systems sufficiently to prevent unsafe vehicle movement while the structure is deployed or moving.

What is needed are improved methods and systems for safe and efficient control of movable vehicle-mounted structures using onboard vehicle sensing and controller-based spatial analysis.

### SUMMARY

Described herein are methods and systems for safe and efficient deployment of a movable vehicle-mounted structure on a truck. An advanced driving controller unit (ADCU) may receive a structure deployment request and obtain spatial information for a structure zone using one or more vehicle sensors, such as cameras, LiDAR, radar, or proximity sensors. The ADCU may analyze the spatial information to evaluate one or more criteria, including object presence, occupancy, free-space, collision risk, or intrusion, and may permit deployment when safe conditions are determined. Sensor data may be processed from single or multiple images, multiple views, and/or other sensing modalities, and may be transformed into a common coordinate frame based on preconfigured, updated, or automatically estimated calibration. Monitoring may continue during deployment. In some examples, the ADCU immobilizes the truck during deployment and, after deployment, evaluates a structure travel zone to support safe vehicle movement.

Clause 1. A method for safe deployment a movable vehicle-mounted structure from a cabin of a truck without a direct line of sight of the movable vehicle-mounted structure, the method comprising: receiving a structure deployment request at an advanced driving controller unit of the truck; obtaining a spatial information of a structure zone using one or more vehicle sensors, wherein: the structure zone corresponds to a footprint of the movable vehicle-mounted structure in a deployed state, and the spatial information of a structure zone is received by the advanced driving controller unit; analyzing the spatial information of the structure zone to determine if the spatial information meets one or more criteria selected from the group consisting of (a) absence of any objects in the structure zone, (b) no occupancy detection in the structure zone, (c) free-space estimation of the structure zone, (d) collision risk assessment of the structure zone, and (e) no intrusion detection of the structure zone , wherein the spatial information is analyzed using the advanced driving controller unit; and if the spatial information meets the one or more criteria, sending instructions to the movable vehicle-mounted structure to deploy the movable vehicle-mounted structure.

Clause 2. The method of clause 1, wherein one or more vehicle sensors are selected from the group consisting of one or more front cameras, one or more side cameras, a rear camera, a LiDAR, a radar, and a proximity sensor.

Clause 3. The method of clause 1, wherein the movable vehicle-mounted structure is selected from the group consisting of a liftgate, a ramp, a step, a door, a hatch, a platform, a carrier, a ladder, and an access panel.

Clause 4. The method of clause 1, further comprising, if the spatial information does not meet one or more criteria, sending a warning to the driver of the truck.

Clause 5. The method of clause 1, further comprising repeating (i) obtaining the spatial information of the structure zone and (ii) analyzing the spatial information of the structure zone while the movable vehicle-mounted structure is being deployed.

Clause 6. The method of clause 1, wherein the structure deployment request is generated using a control switch positioned in the cabin of the truck.

Clause 7. The method of clause 6, wherein the control switch is a part of a driver user interface, further comprising a warning unit.

Clause 8. The method of clause 7, wherein the driver user interface is configured to display the spatial information of the structure zone.

Clause 9. The method of clause 1, further comprising, upon receiving the structure deployment request: determining if the truck is immobilized, and the spatial information of the structure zone is obtained only when the truck is immobilized.

Clause 10. The method of clause 9, further comprising immobilizing the truck in response to receiving the structure deployment request.

Clause 11. The method of clause 10, wherein immobilizing the truck comprises sending a request from the advanced driving controller unit to a vehicle control unit of the truck.

Clause 12. The method of clause 1, wherein the truck is one of a Class 2 truck, a Class 3 truck, a Class 4 truck, or a Class 5 truck.

Clause 13. The method of clause 1, wherein the spatial information comprises one or more of image data, video data, depth information, range information, point-cloud data, radar data, and proximity-sensor data.

Clause 14. The method of clause 1, wherein obtaining the spatial information comprises receiving data from a plurality of vehicle sensors and fusing the data at the advanced driving controller unit.

Clause 15. The method of clause 1, wherein obtaining the spatial information comprises obtaining a temporal sequence of images and analyzing changes over time in the structure zone.

Clause 16. The method of clause 1, wherein obtaining the spatial information comprises obtaining synchronized images from multiple viewpoints of the truck.

Clause 17. The method of clause 1, wherein the spatial information comprises three-dimensional or depth-related information derived using stereo vision, monocular depth estimation, structure-from-motion, multi-view reconstruction, simultaneous localization and mapping (SLAM), or a combination thereof.

Clause 18. The method of clause 1, wherein analyzing the spatial information comprises determining whether a threshold amount of free space is present within the structure zone.

Clause 19. The method of clause 1, wherein analyzing the spatial information comprises determining whether a collision-risk value associated with deployment of the movable vehicle-mounted structure is below a threshold.

Clause 20. The method of clause 1, wherein analyzing the spatial information comprises detecting intrusion of a person, animal, or object into the structure zone during deployment of the movable vehicle-mounted structure.

Clause 21. The method of clause 1, further comprises calibrating one or more vehicle sensors relative to the truck and/or relative to the movable vehicle-mounted structure.

Clause 22. The method of clause 21, wherein the calibrating comprises one or more of intrinsic calibration, extrinsic calibration, alignment with a vehicle coordinate system, and alignment with a structure coordinate system.

Clause 23. The method of clause 21, wherein the calibrating is preconfigured, dynamically updated, automatically estimated, or any combination thereof.

Clause 24. The method of clause 1, wherein obtaining or analyzing the spatial information comprises transforming the spatial information into a common coordinate frame before determining whether one or more criteria are met.

Clause 25. The method of clause 1, wherein, if the spatial information does not meet one or more criteria, the advanced driving controller unit inhibits, pauses, or stops deployment of the movable vehicle-mounted structure.

Clause 26. The method of clause 1, wherein the movable vehicle-mounted structure is a liftgate, the one or more vehicle sensors comprise a rear camera, the spatial information comprises one or more images of a liftgate zone, and analyzing the spatial information comprises determining whether one or more objects are present in the liftgate zone before deployment of the liftgate.

Clause 27. A method for driving a truck with a movable vehicle-mounted structure being deployed, the method comprising: receiving a vehicle drive command at an advanced driving controller unit of the truck while the movable vehicle-mounted structure is deployed; determining a structure travel zone based on the vehicle drive command, wherein the structure travel zone defines an expected trajectory of the movable vehicle-mounted structure while the truck travels in accordance with the vehicle drive command; obtaining a spatial information of the structure travel zone using one or more vehicle sensors of the truck; analyzing the spatial information of the structure travel zone to determine if the spatial information meets one or more criteria selected from the group consisting of (a) absence of any objects in the structure travel zone, (b) no occupancy detection in the structure travel zone, (c) free-space estimation of the structure travel zone, (d) collision risk assessment of the structure travel zone, and (e) no intrusion detection of the structure travel zone , wherein the spatial information is analyzed using the advanced driving controller unit; and if the spatial information does not meet the one or more criteria, sending instructions to stop the truck and sending a warning to a driver of the truck.

Clause 28. The method of clause 27, wherein the vehicle drive command comprises a direction of the truck and a steering wheel angle.

Clause 29. The method of clause 27, wherein (i) receiving the vehicle drive command, (ii) determining the structure travel zone, (iii) obtaining the spatial information of the structure travel zone, and (iv) analyzing the spatial information of the structure travel zone is performed continuously.

Clause 30. The method of clause 27, wherein the structure travel zone is determined as a part of a truck travel zone, defined an expected trajectory of the truck while the truck travels in accordance with the vehicle drive command.

Clause 31. The method of clause 27, wherein the instructions to stop the truck is sent by the advanced driving controller unit to a vehicle control unit.

Clause 32. The method of clause 27, wherein the spatial information comprises one or more of image data, video data, depth information, range information, point-cloud data, radar data, and proximity-sensor data.

Clause 33. The method of clause 27, wherein obtaining the spatial information comprises receiving data from a plurality of vehicle sensors and fusing the data at the advanced driving controller unit.

Clause 34. The method of clause 27, wherein obtaining the spatial information comprises obtaining a temporal sequence of images corresponding to the structure travel zone.

Clause 35. The method of clause 27, wherein obtaining the spatial information comprises obtaining synchronized images from multiple viewpoints of the truck.

Clause 36. The method of clause 27, wherein the spatial information comprises three-dimensional or depth-related information derived using stereo vision, monocular depth estimation, structure-from-motion, multi-view reconstruction, simultaneous localization and mapping (SLAM), or a combination thereof.

Clause 37. The method of clause 27, wherein analyzing the spatial information comprises determining whether a threshold amount of free space is present within the structure travel zone.

Clause 38. The method of clause 27, wherein analyzing the spatial information comprises determining whether a collision-risk value associated with continued travel of the truck with the movable vehicle-mounted structure deployed exceeds a threshold.

Clause 39. The method of clause 27, wherein analyzing the spatial information comprises detecting intrusion of a person, animal, or object into the structure travel zone during movement of the truck.

Clause 40. The method of clause 27, wherein determining the structure travel zone comprises determining a swept area or swept volume associated with the predicted movement of the movable vehicle-mounted structure.

Clause 41. The method of clause 27, further comprising calibrating one or more vehicle sensors relative to the truck and/or relative to the movable vehicle-mounted structure.

Clause 42. The method of clause 41, wherein calibrating comprises one or more of intrinsic calibration, extrinsic calibration, alignment with a vehicle coordinate system, and alignment with a structure coordinate system.

Clause 43. The method of clause 41, wherein calibrating is preconfigured, dynamically updated, automatically estimated, or any combination thereof.

Clause 44. The method of clause 27, wherein obtaining or analyzing the spatial information comprises transforming the spatial information into a common coordinate frame before determining whether one or more criteria are met.

Clause 45. A truck comprising: a cabin; a movable vehicle-mounted structure, wherein the movable vehicle-mounted structure is not fully visible from the cabin; one or more vehicle sensors configured to obtain spatial information corresponding to a structure zone, wherein the structure zone corresponds to a footprint of the movable vehicle-mounted structure in a deployed state; and an advanced driving controller unit configured to: receive a structure deployment request, receive the spatial information corresponding to the structure zone from the one or more vehicle sensors, analyze the spatial information of the structure zone to determine whether the spatial information meets one or more criteria selected from the group consisting of (a) absence of any objects in the structure zone, (b) no occupancy detection in the structure zone, (c) free-space estimation of the structure zone, (d) collision risk assessment of the structure zone, and (e) no intrusion detection of the structure zone , and send instructions to the movable vehicle-mounted structure to deploy the movable vehicle-mounted structure if the spatial information meets the one or more criteria.

Clause 46. The truck of clause 45, wherein the movable vehicle-mounted structure is selected from the group consisting of a liftgate, a ramp, a step, a door, a hatch, a platform, a carrier, a ladder, and an access panel.

Clause 47. The truck of clause 45, wherein one or more vehicle sensors are selected from the group consisting of one or more front cameras, one or more side cameras, one or more rear cameras, a LiDAR, a radar, and a proximity sensor.

Clause 48. The truck of clause 45, wherein the spatial information comprises one or more of image data, video data, depth information, range information, point-cloud data, radar data, proximity-sensor data, and fused sensor data.

Clause 49. The truck of clause 45, further comprising a driver user interface positioned in the cabin and comprising a control switch configured to generate the structure deployment request.

Clause 50. The truck of clause 49, wherein the driver user interface further comprises a warning unit, and wherein the advanced driving controller unit is further configured to send a warning to the driver of the truck if the spatial information does not meet one or more criteria.

Clause 51. The truck of clause 49, wherein the driver user interface is configured to display the spatial information corresponding to the structure zone.

Clause 52. The truck of clause 45, wherein the advanced driving controller unit is further configured to repeatedly obtain and analyze the spatial information corresponding to the structure zone while the movable vehicle-mounted structure is being deployed.

Clause 53. The truck of clause 45, wherein the advanced driving controller unit is further configured to determine whether the truck is immobilized before causing the movable vehicle-mounted structure to deploy.

Clause 54. The truck of clause 53, wherein the advanced driving controller unit is further configured to request immobilization of the truck in response to receiving the structure deployment request.

Clause 55. The truck of clause 54, further comprising a vehicle control unit, wherein the advanced driving controller unit is configured to request immobilization of the truck by sending a request to the vehicle control unit.

Clause 56. The truck of clause 45, wherein the advanced driving controller unit is further configured to derive the spatial information from a single image, a temporal sequence of images, a video stream, synchronized images from multiple viewpoints, stereo image pairs, or any combination thereof.

Clause 57. The truck of clause 45, wherein the advanced driving controller unit is further configured to derive three-dimensional or depth-related information using stereo vision, monocular depth estimation, structure-from-motion, multi-view reconstruction, simultaneous localization and mapping (SLAM), or a combination thereof.

Clause 58. The truck of clause 45, wherein the advanced driving controller unit is further configured to calibrate one or more of the one or more vehicle sensors relative to the truck and/or relative to the movable vehicle-mounted structure.

Clause 59. The truck of clause 58, wherein the calibrate one or more of the one or more vehicle sensors comprises one or more of intrinsic calibration, extrinsic calibration, alignment with a vehicle coordinate system, and alignment with a structure coordinate system.

Clause 60. The truck of clause 58, wherein the calibration is preconfigured, dynamically updated, automatically estimated, or any combination thereof.

Clause 61. The truck of clause 58, wherein the advanced driving controller unit is further configured to transform image data, detections, depth information, point clouds, and/or other spatial information into a common coordinate frame before analyzing the spatial information of the structure zone.

Clause 62. The truck of clause 45, wherein the movable vehicle-mounted structure comprises a liftgate.

Clause 63. The truck of clause 62, wherein one or more vehicle sensors comprise a rear camera configured to obtain the spatial information corresponding to the structure zone, and wherein the structure zone corresponds to a footprint of the liftgate in a deployed state.

Clause 64. The truck of clause 63, wherein the advanced driving controller unit is configured to analyze one or more images obtained by the rear camera to determine whether one or more objects are present in the structure zone before deployment of the liftgate.

Clause 65. The truck of clause 45, wherein the truck is one of a Class 2 truck, a Class 3 truck, a Class 4 truck, or a Class 5 truck.

These and other embodiments are described further below with reference to the figures.

### BRIEF DESCRIPTION OF THE DRAWINGS

FIG. 1A is a schematic side view of a truck before deploying the liftgate, in accordance with some examples.

FIG. 1B is a schematic side view of the truck in FIG. 1A after deploying the liftgate, in accordance with some examples.

FIG. 1C is a schematic top view of the truck in FIG. 1B after deploying the liftgate, in accordance with some examples.

FIG. 2A is a block diagram of various sensors and control units of the truck in FIG. 1A, in accordance with some examples.

FIG. 2B illustrates a block diagram of a computing system, in accordance with some examples.

FIG. 3A is a process flowchart corresponding to a method for safely deploying of a movable vehicle-mounted structure from the truck’s cabin, in accordance with some examples.

FIG. 3B is a process flowchart corresponding to a method for operating the truck with the deployed movable vehicle-mounted structure, in accordance with some examples.

FIGS. 4A and 4B are schematic top views of a truck backing up into a turn with the deployed liftgate, in accordance with some examples.

FIGS. 5A, 5B, and 5C, are schematic views of different points and corresponding travel zones while the truck backs up into a turn with the deployed liftgate, in accordance with some examples.

FIG. 6 is a schematic top view of a truck backing up and turning into a passageway with the deployed liftgate, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscuring the described concepts. While some concepts will be described in conjunction with the specific embodiments, it will be understood that these embodiments are not intended to be limiting.

### Introduction

Described herein are various aspects of comprehensive safety systems for medium-duty trucks (e.g., Class 2 trucks, Class 3 trucks, Class 4 trucks, and/or Class 5 trucks) equipped with movable vehicle-mounted structures (e.g., liftgates) and methods of operating such safety systems. These systems are aimed at preventing accidents and enhancing the operational safety of these trucks. Specifically, a system may utilize one or more sensors for obtaining spatial information of the structure zone and analyzing this spatial information to determine if the spatial information meets one or more criteria (e.g., advanced camera-based detection with vehicle control methodologies to ensure that the liftgate operates only under safe conditions, such as no objects are present in a liftgate zone). This two-pronged approach significantly reduces the risk of injuries or accidents associated with the deployment and vehicle movement.

One aspect of this system is sensor-based operation. In a liftgate example, a truck may be equipped with a rear camera, which is used by an advanced driving controller unit (ADCU) to actively monitor the area behind the truck for any obstacles or individuals, particularly focusing on the zones directly affected by liftgate operations, which may be referred to as a liftgate zone. The ADCU uses advanced image recognition algorithms to analyze images (e.g., in the form of a video feed) in real-time. If an object (e.g., a person, an animal, an obstacle) is detected within the liftgate zone, the ADCU prevents any liftgate deployment or, if one is being deployed, automatically halts any further liftgate deployment and alerts the driver, thus preventing potential injuries or accidents.

In some examples, the ADCU may obtain spatial information from one or more sensing modalities, including one or more cameras, LiDAR sensors, radar sensors, ultrasonic sensors, proximity sensors, infrared sensors, depth sensors, and/or other sensors configured to provide scene, range, motion, or occupancy information. Such sensing may be used with respect to a liftgate example or with respect to other movable vehicle-mounted structures and associated deployment zones, swept areas, swept volumes, clearance regions, or travel zones. In some examples, the ADCU may analyze the spatial information not only for object detection, but also for occupancy detection, free-space estimation, collision risk assessment, intrusion detection, clearance verification, or other spatial reasoning relevant to safe structure operation.

In some examples, the spatial information may be derived from a single image, a temporal sequence of images, a video stream, synchronized images from multiple viewpoints, stereo image pairs, fused measurements from multiple sensors, or any combination thereof. In some examples, three-dimensional and/or depth information may be determined using stereo vision, monocular or learned depth estimation, structure-from-motion, multi-view reconstruction, visual odometry, simultaneous localization and mapping (SLAM), point-cloud processing, or other suitable techniques. The disclosed concepts are not limited to any particular algorithm, model, or implementation, and may be realized using rule-based, geometric, probabilistic, machine-learning, or hybrid approaches.

In general, movable vehicle-mounted structures may be provided on trucks, trailers, vans, service vehicles, delivery vehicles, and other vehicles to support loading, unloading, access, transport, storage, servicing, and other vehicle-related operations. Such structures may be hydraulically, electrically, pneumatically, and/or mechanically actuated, and may be configured to translate, pivot, swing, fold, extend, retract, raise, lower, or otherwise move relative to the vehicle.

In some examples, a movable vehicle-mounted structure may comprise a liftgate used to bridge a height difference between ground level and a cargo floor. In other examples, the movable vehicle-mounted structure may comprise a ramp, a retractable or deployable step, a side or rear door, a hatch, a cargo access panel, a platform, a carrier, a ladder assembly, or another component that changes position relative to the vehicle during operation. Such structures may be used to facilitate cargo handling, operator entry and exit, equipment access, maintenance, passenger access, or other functions.

During operation, a movable vehicle-mounted structure may occupy or move through one or more regions adjacent to the vehicle, such as a deployment zone, a swept area, a swept volume, a clearance region, or a travel zone. For example, a ramp may extend rearward or sideward from the vehicle, a step may deploy downward into a pedestrian space, a door or hatch may swing into a surrounding area, and a carrier or ladder assembly may move into a region that could interfere with nearby objects or persons. As such, these structures can improve vehicle functionality and operator convenience, but may also create safety and clearance considerations during deployment, retraction, and use.

Another aspect is a vehicle control interlock for the operation of a movable vehicle-mounted structure and vehicle movement. Specifically, the ADCU may determine whether the truck is immobilized (e.g., not able to move based on gear selection, parking brake status, engine state, wheel speed, transmission state, or other vehicle operating conditions). The ADCU may prevent a movable vehicle-mounted structure from being deployed, extended, lowered, opened, or otherwise actuated while the truck is in motion or, in some examples, while the truck is able to move.

Furthermore, the ADCU may maintain the truck immobilized while the movable vehicle-mounted structure is being deployed, retracted, moved, or is in a deployed or otherwise use position. For example, this functionality may be applied to a liftgate, ramp, deployable step, door, hatch, access panel, platform, carrier, ladder assembly, or another actuated vehicle-mounted component. A set of sensors, such as one or more cameras, structure-position sensors, proximity sensors, LiDAR sensors, radar sensors, or other vehicle sensors, together with various configurations of the ADCU, may be used to support such interlock control and associated safety determinations.

In some examples, operation of the ADCU may further involve calibration and coordinate alignment among one or more sensors, the vehicle, and the movable vehicle-mounted structure. For example, calibration may include intrinsic calibration of a camera or other sensor, extrinsic calibration between sensors, and/or alignment with a vehicle-fixed coordinate system, a structure-fixed coordinate system, or another common reference frame. In some examples, such calibration may be preconfigured, updated during operation, or automatically estimated from sensed data. The ADCU may transform image data, detections, depth information, point clouds, or other spatial information into the common coordinate frame to support spatial reasoning with respect to a current or predicted position, footprint, or swept volume of the movable vehicle-mounted structure.

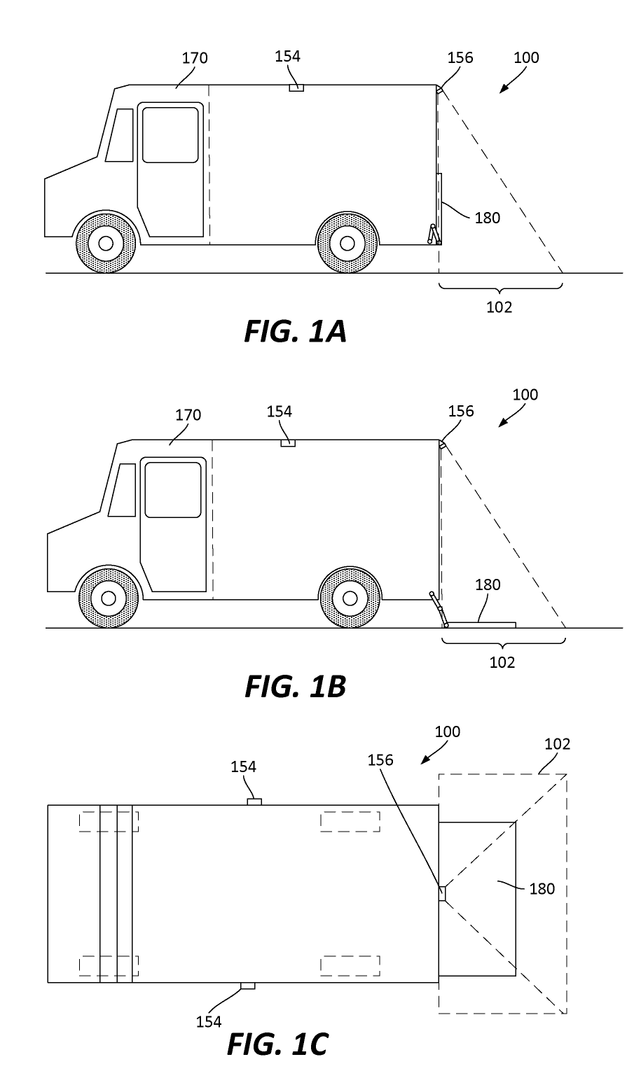

### FIGS. 1A-1C: Examples of Trucks with Liftgates

FIG. 1A is a schematic side view of truck 100 comprising a liftgate 180, prior to deploying the liftgate 180, in accordance with some examples. The liftgate 180 is positioned on the back of truck 100 and may comprise a liftgate actuator 182 and a liftgate platform 184. Furthermore, truck 100 is equipped with a rear camera 156, which may be used by the driver to observe the space behind truck 100. It should be noted that due to the width and length of the truck 100, a significant part of the truck’s surroundings may not be directly observable by the driver from the truck’s cabin 170. Specifically, liftgate 180 may not be directly visible from the cabin 170 (the cabin 170 does not have a direct line of sight of the liftgate 180).

Although FIGS. 1A-1C and the associated description refer to liftgate 180, the liftgate 180 is only one example of a movable vehicle-mounted structure. In some examples, other movable vehicle-mounted structures, such as ramps, steps, doors, hatches, cargo access panels, platforms, carriers, ladder assemblies, and other deployable, retractable, pivotable, extendable, or otherwise actuated vehicle-mounted components, may be used in place of or in addition to liftgate 180. Other examples of movable vehicle-mounted structures and corresponding implementations will be understood by one having ordinary skill in the art in view of the present disclosure.

The liftgate 180 is associated with structure zone 102, which corresponds to the footprint of the liftgate 180 in a deployed state. It should be noted that the structure zone 102 may be larger than the exact footprint of the liftgate 180 since the liftgate 180 may block/hide a portion of the exact footprint of the liftgate 180 from the rear camera 156. In other words, a portion of the ground where the liftgate 180 will eventually reside in the deployed state may not be visible to the rear camera 156 when the liftgate 180 is moving from the retracted state in FIG. 1A and the deployed state in FIG. 1B. As such, the structure zone 102 may extend beyond this blocked portion to ensure that objects do not enter the structure zone 102, e.g., during the deployment of the liftgate 180. FIG. 1C is a schematic top view of the truck 100 in FIG. 1B after deploying the liftgate 180, illustrating the structure zone 102 relative to the footprint of the liftgate 180 and relative to the position of the truck 100.

In some examples, the truck 100 is one of a Class 2 truck, a Class 3 truck, a Class 4 truck, or a Class 5 truck. Specific examples of the truck 100 include, but are not limited to, a step van, a walk-in truck, a box truck, and the like.

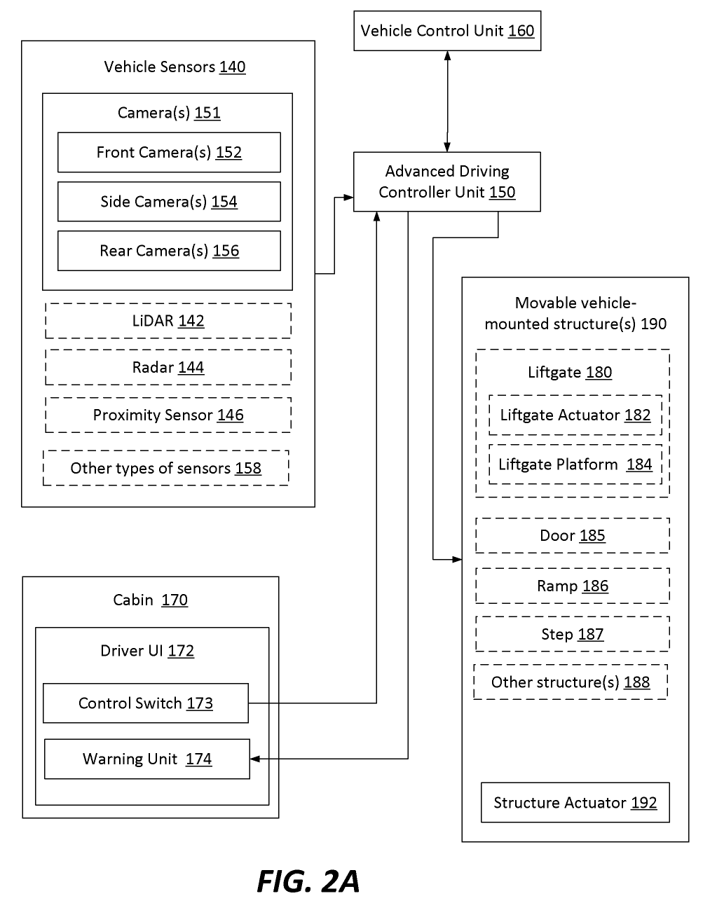

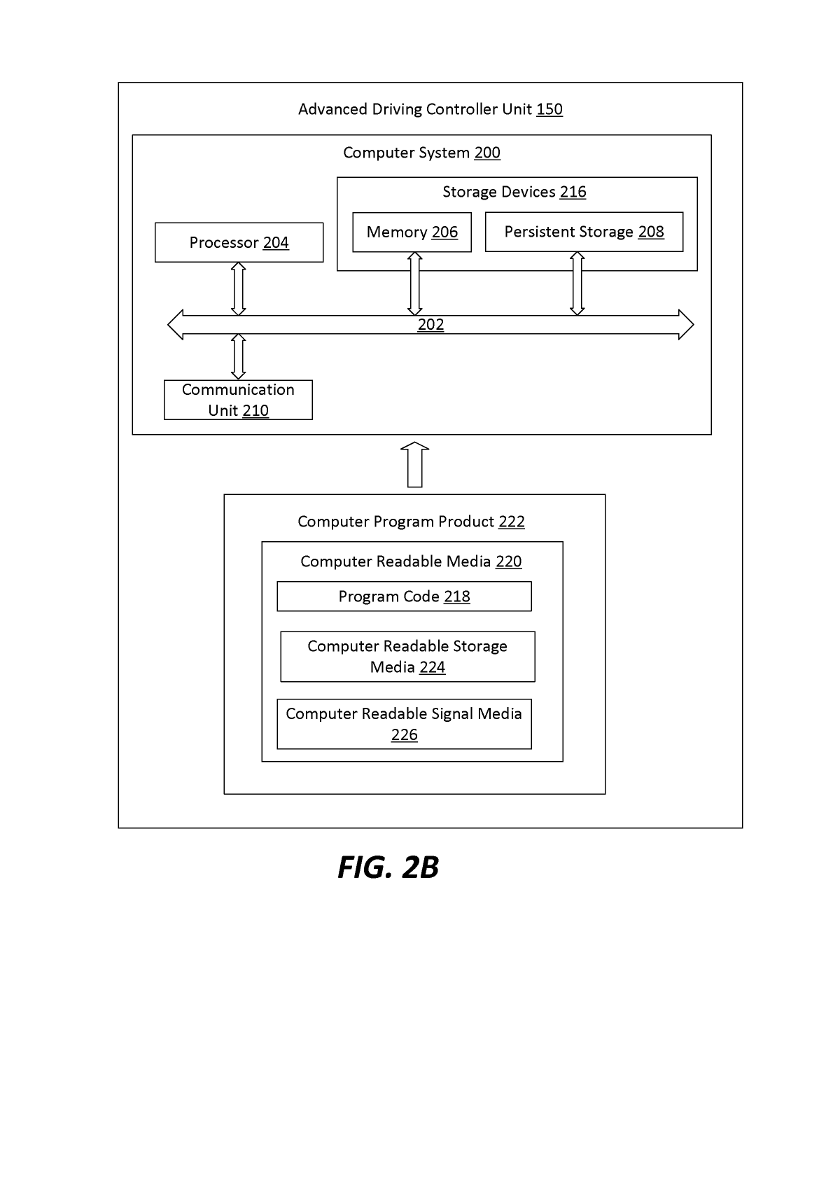

### FIG. 2A: Block Diagram of a Truck Examples

FIG. 2A is a block diagram of various sensors, control units, user-interface components, and movable vehicle-mounted structures of the truck 100 in FIG. 1A, in accordance with some examples. Specifically, the truck 100 comprises an advanced driving controller unit 150 configured to control the operation of one or more movable vehicle-mounted structures 190 and, in some examples, one or more other systems of the truck 100 associated with vehicle operation, safety interlocks, and driver assistance. In some examples, the advanced driving controller unit 150 is communicatively coupled to vehicle sensors 140, vehicle control unit 160, cabin 170, driver user interface 172, and one or more movable vehicle-mounted structures 190 and/or one or more corresponding structure actuators 192. In some examples, advanced driving controller unit 150 receives sensor data and user inputs, performs spatial analysis and safety determinations, and generates control signals, warnings, interlock commands, or other instructions for controlling deployment, retraction, movement, stopping, pausing, or permitting operation of movable vehicle-mounted structures 190.

In some examples, vehicle sensors 140 comprise a set of cameras 151, such as one or more front cameras 152, one or more side cameras 154, and one or more rear cameras 156. For example, one or more front cameras 152 may include multiple forward-facing cameras having different fields of view, focal lengths, mounting positions, or resolutions, and, in some examples, may further include a driver-facing camera for monitoring driver state or driver attention. One or more side cameras 154 may include cameras positioned on opposite sides of the truck to observe lateral regions, side clearance regions, and areas adjacent to one or more movable vehicle-mounted structures 190. One or more rear cameras 156 may be configured to obtain image data corresponding to structure zone 102, structure travel zone 104, and/or other regions adjacent to truck 100 that may be relevant to deployment, retraction, movement, or use of one or more movable vehicle-mounted structures 190. In some examples, a set of cameras 151 is communicatively coupled to an advanced driving controller unit 150 for providing corresponding image data, video data, or other camera-based information to the advanced driving controller unit 150.

In some examples, vehicle sensors 140 further comprise one or more LiDAR sensors 142, one or more radar sensors 144, one or more proximity sensors 146, and/or one or more other types of sensors 158 configured to sense the surroundings of truck 100 and/or one or more movable vehicle-mounted structures 190. In some examples, such other types of sensors 158 may include ultrasonic sensors, infrared sensors, depth sensors, time-of-flight sensors, structure-position sensors, inertial sensors, wheel-speed sensors, steering-angle sensors, or other sensors capable of providing spatial, positional, motion-related, environmental, or state-related information. In some examples, advanced driving controller unit 150 receives spatial information from one sensing modality or from multiple sensing modalities and may fuse, correlate, compare, register, weight, prioritize, or otherwise process such spatial information to support safe operation of movable vehicle-mounted structures 190. In some examples, different sensing modalities may provide complementary information, such as image appearance information, range information, motion information, occupancy information, and/or proximity information.

In some examples, the spatial information received from vehicle sensors 140 is not limited to a single image or to simple object detection. For example, advanced driving controller unit 150 may process one or more single images, a video stream, a temporal sequence of images, stereo image pairs, synchronized images from multiple viewpoints, LiDAR point clouds, radar measurements, proximity measurements, and/or fused sensor outputs derived from multiple sensors. In some examples, advanced driving controller unit 150 may analyze such spatial information to determine one or more conditions selected from absence of one or more objects, no/limited occupancy of a zone, free-space availability, no collision risk, lack of intrusion into a protected region, clearance of a swept area or swept volume, above-the-threshold proximity to one or more objects, predicted interaction between the structure and surrounding environment, and/or another spatial condition relevant to operation of movable vehicle-mounted structures 190. In some examples, such analysis may be performed with respect to a current zone, a predicted future zone, a moving zone, or a zone corresponding to the expected motion of the vehicle and/or expected motion of one or more movable vehicle-mounted structures 190.

In some examples, three-dimensional and/or depth-related information may be determined using stereo vision, monocular depth estimation, structure-from-motion, multi-view reconstruction, simultaneous localization and mapping (SLAM), point-cloud processing, sensor fusion, and/or other suitable techniques. In some examples, such techniques may be used to determine a ground plane, identify occupied and unoccupied regions, estimate distances or clearances, determine a height or extent of one or more obstacles, and/or predict whether a movable vehicle-mounted structure 190 may contact a person, animal, cargo item, fixed object, or other obstacle during operation. In some examples, the disclosed concepts are not limited to any particular algorithm, model, or implementation and may be carried out using image-processing techniques, geometric techniques, probabilistic techniques, machine-learning techniques, rule-based techniques, model-based techniques, heuristic techniques, or combinations thereof. In some examples, the same system may use different techniques under different operating conditions, sensor configurations, or vehicle states.

In some examples, one or more of the vehicle sensors 140 may be calibrated relative to each other, relative to truck 100, and/or relative to one or more movable vehicle-mounted structures 190. For example, such calibration may include intrinsic calibration, extrinsic calibration, alignment with a vehicle coordinate system, alignment with a structure coordinate system, alignment with a ground-plane reference, and/or alignment with another common reference frame used for spatial reasoning. In some examples, calibration may be preconfigured, dynamically updated during operation, and/or automatically estimated based on sensed data, observed environmental features, known structure positions, known vehicle geometry, or other reference information. In some examples, advanced driving controller unit 150 transforms image data, detections, depth information, point clouds, range measurements, and/or other spatial information into a common coordinate frame to support spatial reasoning with respect to a current or predicted position, footprint, trajectory, swept area, swept volume, or clearance envelope of one or more movable vehicle-mounted structures 190. In some examples, such a coordinate transformation may improve consistency among sensing modalities and may support safer control decisions across different vehicle conditions and structure positions.

Referring to FIG. 2A, the truck 100 comprises a cabin 170, which may be equipped with a driver user interface 172. Specifically, driver user interface 172 is positioned in cabin 170 and comprises control switch 173, which may be a physical switch, a touchscreen field, a soft control presented on a display, a voice-activated control, or another user input component. In some examples, control switch 173, or more generally driver user interface 172, is configured to generate a structure deployment request, a structure retraction request, a structure movement request, a structure stop request, and/or another structure control request, which is sent to advanced driving controller unit 150 for further processing. In some examples, driver user interface 172 further comprises warning unit 174 configured to present a warning, status indication, instruction, recommendation, or other output to the driver. In some examples, driver user interface 172 is configured to display image data, spatial information, occupancy information, free-space information, collision-risk information, intrusion information, structure position information, and/or other information associated with structure zone 102, structure travel zone 104, and/or another region relevant to the operation of movable vehicle-mounted structures 190. Furthermore, in some examples, driver user interface 172 may support acknowledgment inputs, override requests, confirmation inputs, or other interaction functions associated with the operation of movable vehicle-mounted structures 190.

In some examples, advanced driving controller unit 150 is configured to receive a structure deployment request, obtain spatial information corresponding to structure zone 102 from one or more vehicle sensors 140, analyze the spatial information to determine whether one or more safety criteria are satisfied, and send instructions to one or more movable vehicle-mounted structures 190 and/or one or more structure actuators 192 to deploy, retract, move, stop, pause, slow, or otherwise control the movable vehicle-mounted structures 190.

In some examples, movable vehicle-mounted structures 190 comprise a liftgate 180, door 185, ramp 186, step 187, and/or one or more other structures 188. In some examples, one or more structure actuators 192 may include a liftgate actuator 182 and/or another actuator configured to move, position, or secure a corresponding movable vehicle-mounted structure 190. In some examples, one or more safety criteria are based on the absence/presence of one or more objects, occupancy detection, free-space estimation, collision risk assessment, intrusion detection, clearance determination, predicted path interference, and/or another spatial analysis result.

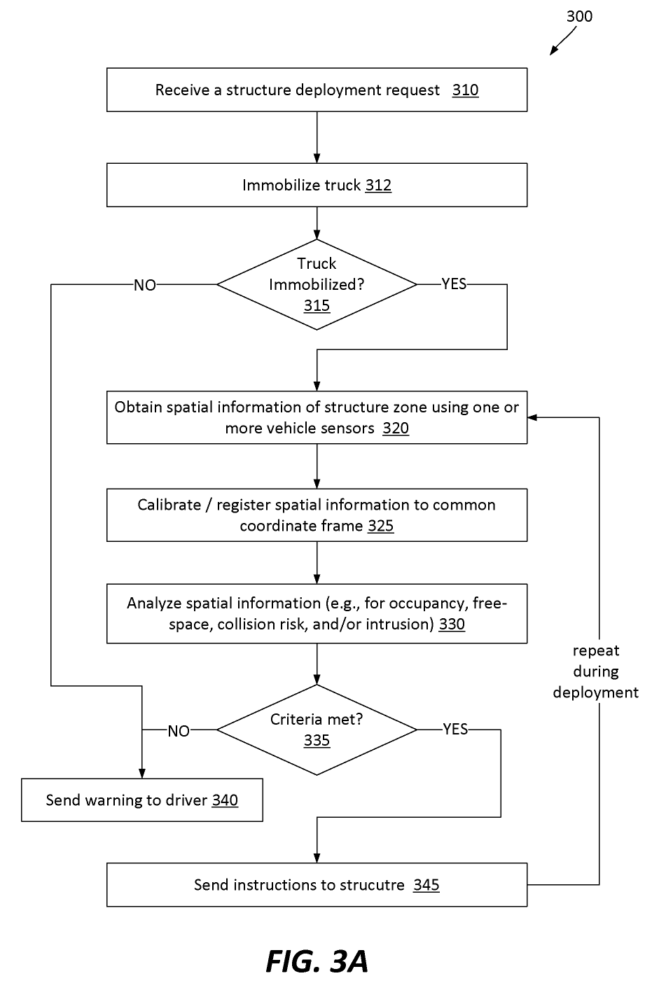

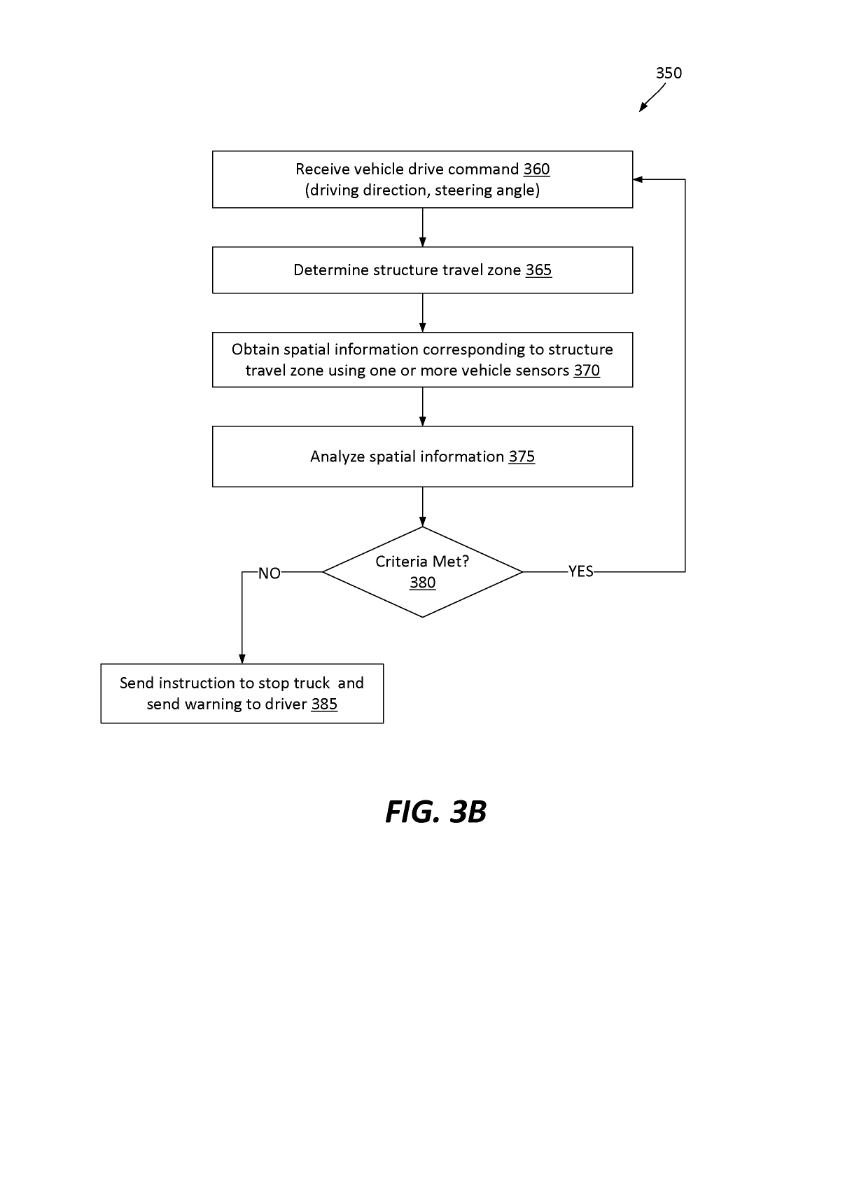

In some examples, advanced driving controller unit 150 may also provide one or more warnings to driver user interface 172, may request immobilization of truck 100 through vehicle control unit 160, and/or may maintain an interlock condition while the corresponding movable vehicle-mounted structure 190 is deployed or moving. Various aspects of these functions and corresponding operations are described below with reference to FIGS. 3A and 3B.

### FIG. 2B: Advanced Driving Controller Unit Examples

FIG. 2B illustrates a block diagram of a computing system, which may be operable as an advanced driving controller unit 150, in accordance with some examples. One or more components of computer system 200 may be implemented as onboard components, such as one or more electronic control units (ECUs), domain controllers, perception controllers, motion controllers, and/or other computing devices of truck 100. In various examples, computer system 200 includes communications framework 202, such as a bus or another interconnect structure, which provides communications among processor unit 204, memory 206, persistent storage 208, and communications unit 210. Communications unit 210 provides for communications with other vehicle systems, sensors, actuators, and devices. For example, communications unit 210 may be communicatively coupled to vehicle sensors 140, vehicle control unit 160, driver user interface 172, movable vehicle-mounted structure(s) 190, and/or structure actuator 192. In these illustrative examples, communications unit 210 may comprise a network interface card, a CAN bus device, an Ethernet interface, a LIN interface, a universal serial bus (USB) interface, a wireless communication interface, and/or another suitable communications device or interface. In some examples, computer system 200 may receive sensor data, structure state data, vehicle state data, and user inputs, and may transmit warnings, interlock commands, deployment commands, stop commands, movement commands, or other control signals associated with safe operation of one or more movable vehicle-mounted structures.

Processor unit 204 serves to execute instructions for software that may be loaded into memory 206. Processor unit 204 may be a number of processors, a multi-core processor, a graphics processing unit, a neural processing unit, a digital signal processor, a microcontroller, or some other type of processor, depending on the particular implementation. In some examples, processor unit 204 executes instructions for obtaining, receiving, filtering, synchronizing, fusing, transforming, and analyzing spatial information from one or more sensing modalities, including camera data, LiDAR data, radar data, proximity-sensor data, and/or data from other types of sensors 158. In some examples, processor unit 204 may execute instructions for controlling operation of one or more movable vehicle-mounted structures 190, such as liftgate 180, door 185, ramp 186, step 187, and/or other structure(s) 188, based on analysis of structure zone 102, structure travel zone 104, and/or another region relevant to structure deployment, retraction, movement, or use.

In some examples, processor unit 204 may execute instructions that support spatial reasoning beyond simple camera-based object detection. For example, processor unit 204 may determine whether one or more regions are occupied, unoccupied, partially occupied, obstructed, intruded upon, or otherwise unsuitable for structure actuation. In some examples, processor unit 204 may perform occupancy detection, free-space estimation, collision risk assessment, intrusion detection, clearance determination, path-interference analysis, swept-area analysis, swept-volume analysis, and/or other spatial analyses relevant to safe operation of movable vehicle-mounted structures. In some examples, such analyses may be based on current sensor measurements, historical sensor measurements, predicted motion of truck 100, predicted motion of one or more movable vehicle-mounted structures 190, and/or a combination thereof. As such, advanced driving controller unit 150 may determine not only whether an object is presently detected, but also whether deployment or movement of a structure is likely to create an unsafe condition within a current zone or a predicted future zone.

In some examples, processor unit 204 may execute instructions for processing spatial information derived from one image, multiple images, one video stream, multiple synchronized video streams, stereo image pairs, temporally separated image frames, multiple viewpoints, range measurements, point clouds, and/or fused sensor outputs. In some examples, processor unit 204 may derive three-dimensional and/or depth-related information using stereo vision, monocular depth estimation, structure-from-motion, multi-view reconstruction, simultaneous localization and mapping (SLAM), visual odometry, point-cloud processing, radar-based ranging, LiDAR-based ranging, and/or other suitable techniques. In some examples, these techniques may be used to estimate a ground plane, determine distances to one or more objects, estimate heights or extents of obstacles, determine free-space boundaries, predict encroachment into a protected region, and/or estimate whether a structure footprint, trajectory, swept area, or swept volume will intersect a person, animal, cargo item, fixed object, or other obstacle. The disclosed concepts are not limited to any particular image-processing, computer-vision, geometric, probabilistic, machine-learning, heuristic, or rule-based algorithm, and may be implemented using any suitable combination of such approaches.

Memory 206 and persistent storage 208 are examples of storage devices 216, such as computer-readable storage components. Memory 206 may be a random access memory (RAM) or another suitable volatile and/or non-volatile storage device. Persistent storage 208 may take various forms, such as a hard drive, a flash memory, a solid-state drive, or some combination thereof. Instructions for the operating system, applications, services, and/or programs may be located in storage devices 216. The techniques of the different examples may be performed by processor unit 204 using computer-implemented instructions, which may be located in a memory, such as memory 206. In some examples, memory 206 and/or persistent storage 208 may store sensor data, image data, video data, point-cloud data, radar measurements, proximity measurements, structure state information, vehicle state information, zone definitions, safety criteria, warning criteria, interlock criteria, and/or control parameters used by advanced driving controller unit 150.

In some examples, memory 206 and/or persistent storage 208 may further store calibration data, registration data, coordinate transformation data, vehicle geometry data, structure geometry data, and/or reference information used to relate one sensing modality to another and to relate sensed information to truck 100 and movable vehicle-mounted structures 190. For example, stored data may include intrinsic calibration parameters for one or more cameras or other sensors, extrinsic calibration parameters among sensors, alignment data for a vehicle coordinate system, alignment data for a structure coordinate system, and/or parameters defining another common reference frame. In some examples, such calibration data may be preconfigured during manufacturing, service, or installation, may be updated during operation, and/or may be automatically estimated or refined from observed sensor data, known reference objects, known vehicle geometry, known structure positions, or other information. In some examples, processor unit 204 may use these stored parameters to transform image data, detections, depth estimates, point clouds, range measurements, and/or other spatial information into a common coordinate frame for improved spatial reasoning, sensor fusion, and control of one or more movable vehicle-mounted structures.

These instructions are referred to as program code, computer-usable program code, or computer-readable program code. The program code in the different examples may be embodied in different physical or computer-readable storage media, such as memory 206 or persistent storage 208. Program code 218 is located in a functional form on computer-readable media 220 that may be loaded onto or transferred to computer system 200 for execution by processor unit 204. Program code 218 and computer-readable media 220 form computer program product 222 in these illustrative examples. In one example, computer-readable media 220 may be computer-readable storage media 224 or computer-readable signal media 226.

In some examples, program code 218 may include instructions for one or more software modules or functional blocks configured to perform sensor interfacing, sensor synchronization, sensor fusion, calibration, coordinate transformation, zone generation, image processing, depth estimation, spatial reasoning, risk scoring, warning generation, structure interlock control, actuator control, and/or communication with other vehicle systems. In some examples, program code 218 may include instructions for generating, updating, and evaluating structure zone 102, structure travel zone 104, a swept area, a swept volume, a clearance envelope, and/or another spatial representation associated with a movable vehicle-mounted structure. In some examples, program code 218 may further include instructions for determining whether one or more safety criteria are satisfied and, based on that determination, authorizing deployment, authorizing movement, delaying actuation, pausing motion, stopping motion, maintaining truck immobilization, and/or issuing one or more warnings to driver user interface 172 or another system. In some examples, such program code may support liftgate-related operations as well as operations associated with other movable vehicle-mounted structures, such as doors, ramps, steps, hatches, access panels, carriers, ladder assemblies, and other actuated vehicle-mounted components.

In these illustrative examples, computer-readable storage media 224 is a physical or tangible storage device used to store program code 218 rather than a medium that propagates or transmits program code 218. In further examples, computer-readable storage media 224 may store executable instructions and associated data sets used for processing one or more images, multiple images, video sequences, stereo image pairs, multi-view image data, point clouds, radar measurements, proximity measurements, and/or fused multi-sensor data. Computer-readable storage media 224 may further store trained models, geometric models, occupancy maps, free-space maps, lookup tables, threshold values, calibration parameters, vehicle and structure dimensions, and/or other data structures used by advanced driving controller unit 150 in connection with sensor analysis, coordinate-frame transformations, spatial reasoning, and control of movable vehicle-mounted structures. The disclosed concepts are not limited to any particular data format, software architecture, or storage arrangement.

Alternatively, program code 218 may be transferred to computer system 200 using computer-readable signal media 226. Computer-readable signal media 226 may be, for example, a propagated data signal containing program code 218. For example, computer-readable signal media 226 may be an electromagnetic signal, an optical signal, and/or another suitable type of signal. These signals may be transmitted over communications links, such as wireless communications links, optical fiber cables, coaxial cables, a wire, and/or another suitable type of communications link. In some examples, computer-readable signal media 226 may also be used to communicate updated calibration information, updated software modules, updated control logic, updated risk criteria, updated spatial models, and/or other information used by advanced driving controller unit 150. In some examples, such transferred information may support preconfigured, dynamically updated, and/or automatically estimated calibration, may modify processing of one or more sensing modalities, and/or may update how the advanced driving controller unit 150 evaluates occupancy, free space, collision risk, intrusion, or other spatial conditions associated with operation of one or more movable vehicle-mounted structures.

### FIG. 3A: Methods of Deployment of Movable Vehicle-Mounted Structures

FIG. 3A is a process flowchart corresponding to method 300 for the safe deployment of a movable vehicle-mounted structure 190 of truck 100. Various examples of trucks are described above, including medium-duty trucks and, in some examples, Class 2 trucks, Class 3 trucks, Class 4 trucks, and/or Class 5 trucks. In further examples, movable vehicle-mounted structure 190 may comprise liftgate 180, door 185, ramp 186, step 187, and/or another vehicle-mounted structure configured to deploy, retract, pivot, extend, lower, raise, or otherwise move relative to truck 100. The movable vehicle-mounted structure 190 may be controlled from cabin 170 without a direct line of sight of movable vehicle-mounted structure 190, and method 300 is used to determine whether deployment of movable vehicle-mounted structure 190 is permissible based on spatial information corresponding to structure zone 102.

Method 300 may comprise, at block 310, receiving a structure deployment request at the advanced driving controller unit 150 of truck 100. In some examples, the structure deployment request is generated using control switch 173 positioned in cabin 170 of truck 100. As noted above, control switch 173 may be part of driver user interface 172, which may further comprise warning unit 174. In some examples, driver user interface 172 is configured to display spatial information corresponding to structure zone 102, such as image data, depth information, occupancy information, free-space information, collision-risk information, and/or another representation of conditions relevant to deployment of movable vehicle-mounted structure 190. The structure deployment request may correspond to an initial deployment request, a partial deployment request, a continued deployment request, or another request to move movable vehicle-mounted structure 190 from a stowed position toward a deployed position.

In some examples, method 300 further comprises, at block 312, immobilizing truck 100 in response to receiving the structure deployment request. For example, immobilizing truck 100 may comprise sending a request from advanced driving controller unit 150 to vehicle control unit 160 of truck 100. In some examples, immobilization may be based on one or more vehicle conditions, such as transmission state, gear selection, parking brake status, engine state, wheel-speed information, or another indication that truck 100 is in motion or is able to move. In some examples, advanced driving controller unit 150 may request or maintain an interlock condition that inhibits vehicle movement while movable vehicle-mounted structure 190 is being evaluated for deployment and/or while movable vehicle-mounted structure 190 is being deployed.

Method 300 may proceed with decision block 315 to determine whether truck 100 is immobilized. If truck 100 is immobilized, method 300 may proceed with one or more subsequent operations described below. Alternatively, if truck 100 is not immobilized, method 300 may proceed with block 340 to send a corresponding warning to the driver, such as a warning instructing the driver to immobilize truck 100 before deployment of movable vehicle-mounted structure 190. In some examples, method 300 does not proceed to the acquisition of spatial information for deployment authorization until truck 100 is immobilized. In some examples, the warning may be provided using warning unit 174, driver user interface 172, an audible output, a visual output, a haptic output, or another driver notification mechanism.

Method 300 may proceed with block 320 by obtaining spatial information corresponding to structure zone 102 using one or more vehicle sensors 140 of truck 100. In some examples, structure zone 102 corresponds to a footprint of movable vehicle-mounted structure 190 in a deployed state. In some examples, structure zone 102 may further correspond to a swept area, swept volume, clearance region, intrusion region, or another region associated with the expected movement or presence of movable vehicle-mounted structure 190. The spatial information corresponding to structure zone 102 is received by the advanced driving controller unit 150. In some examples, one or more vehicle sensors 140 are selected from one or more front cameras 152, one or more side cameras 154, one or more rear cameras 156, one or more LiDAR sensors 142, one or more radar sensors 144, one or more proximity sensors 146, and/or one or more other sensors 158. In some examples, the spatial information may comprise image data, video data, depth information, range information, point-cloud data, radar measurements, proximity measurements, fused sensor data, or another sensor-derived representation of conditions in or around structure zone 102.

In some examples, block 320 may involve obtaining spatial information from a single image, a temporal sequence of images, a video stream, one or more stereo image pairs, synchronized images from multiple viewpoints, data from one or more non-camera sensors, or any combination thereof. In some examples, advanced driving controller unit 150 may extract one or more image frames from a video stream, may temporally combine information from multiple image frames, may combine information from multiple viewpoints, and/or may fuse camera-derived information with LiDAR-derived, radar-derived, proximity-derived, or other sensor-derived information. Three-dimensional and/or depth-related information may be derived using stereo vision, monocular depth estimation, structure-from-motion, multi-view reconstruction, simultaneous localization and mapping (SLAM), point-cloud processing, range estimation, or another suitable technique. In some examples, the disclosed process is not limited to any particular image-processing, computer-vision, geometric, probabilistic, machine-learning, heuristic, or rule-based algorithm.

In some examples, the spatial information obtained at block 320 may be calibrated, registered, and/or transformed prior to or as part of subsequent analysis. For example, one or more cameras or other sensors may be intrinsically calibrated and/or extrinsically calibrated relative to each other, relative to truck 100, and/or relative to movable vehicle-mounted structure 190. Such calibration may be preconfigured, dynamically updated during operation, and/or automatically estimated based on sensed data. In some examples, advanced driving controller unit 150 may transform image data, depth information, point clouds, detections, and/or other spatial information into a common coordinate frame, such as a vehicle-fixed coordinate system, a structure-fixed coordinate system, a ground-plane reference frame, or another common reference frame, to support more accurate spatial reasoning with respect to structure zone 102.

Method 300 may proceed with block 330 by analyzing the spatial information corresponding to structure zone 102 using advanced driving controller unit 150 to determine whether one or more deployment criteria are satisfied. In some examples, one or more deployment criteria are selected from or based on the absence of one or more objects in structure zone 102, no/limited occupancy detection in structure zone 102, free-space estimation for structure zone 102, collision risk assessment for structure zone 102, and/or intrusion detection with respect to structure zone 102. In some examples, analysis at block 330 may further include clearance determination, swept-area analysis, swept-volume analysis, trajectory-based risk assessment, or another spatial reasoning operation relevant to deployment of movable vehicle-mounted structure 190. Advanced driving controller unit 150 may determine whether structure zone 102 is sufficiently clear, whether a threshold amount of free space is available, whether a collision-risk value is below a threshold, whether an intrusion has occurred or is predicted, and/or whether another deployment-permission condition is satisfied.

In some examples, the analysis at block 330 may be based on current sensor data, temporally accumulated sensor data, predicted motion of movable vehicle-mounted structure 190, and/or predicted motion of truck 100. In further examples, the analysis may use one or more two-dimensional, depth-based, and/or three-dimensional representations of the environment adjacent to truck 100. Advanced driving controller unit 150 may compare the calibrated and transformed spatial information to a model, footprint, trajectory, swept area, swept volume, or clearance envelope of movable vehicle-mounted structure 190 in a deployed state or during movement toward the deployed state. In some examples, if the spatial information satisfies one or more deployment criteria at decision block 335, method 300 proceeds with block 345, and advanced driving controller unit 150 sends instructions to movable vehicle-mounted structure 190 to deploy movable vehicle-mounted structure 190. Alternatively, if the spatial information does not satisfy one or more deployment criteria, method 300 may proceed with block 340 to send a warning to the driver of truck 100.

In some examples, liftgate 180 is the movable vehicle-mounted structure 190. In these examples, structure zone 102 may correspond to a liftgate zone associated with a footprint of liftgate 180 in a deployed state, and the spatial information may comprise one or more images obtained using rear camera 156. Advanced driving controller unit 150 may analyze one or more images to determine whether one or more objects are present in the liftgate zone and, if the liftgate zone is clear, may send instructions to liftgate 180 to deploy. As such, the broader method 300 described herein expressly encompasses a liftgate-specific implementation in which rear-camera image analysis is used to control liftgate deployment.

In some examples, the operations of obtaining the spatial information corresponding to structure zone 102 and analyzing the spatial information corresponding to structure zone 102 are repeated while movable vehicle-mounted structure 190 is being deployed. Such repeated operations may be continuous, periodic, event-driven, frame-based, sensor-update-based, or otherwise iteratively performed during deployment. This feature may ensure that one or more objects do not enter the structure zone 102 while the movable vehicle-mounted structure 190 is being deployed and may allow the advanced driving controller unit 150 to pause, slow, stop, inhibit, or otherwise modify deployment if a condition changes during movement of the movable vehicle-mounted structure 190. In some examples, the repeated analysis may stop once movable vehicle-mounted structure 190 reaches a fully deployed state, a partially deployed state, a commanded position, or another target position. Monitoring may continue after deployment for purposes of maintaining an interlock condition, presenting warnings, or supporting subsequent vehicle operation with movable vehicle-mounted structure 190 in the deployed state.

### FIGS. 3B: Methods of Driving Trucks with Deployed Vehicle-Mounted Structures

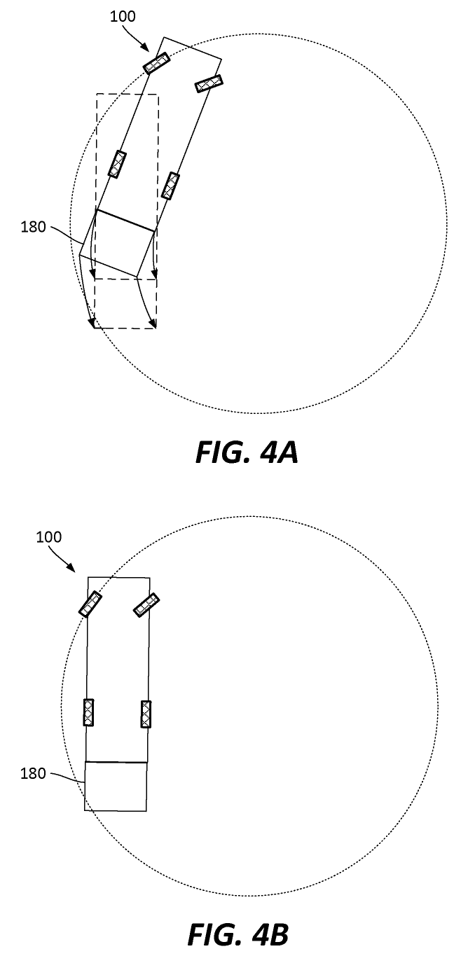

FIG. 3B is an example of a method 350 for driving a truck 100 with a movable vehicle-mounted structure 190 in a deployed state, in accordance with some examples. In some examples, movable vehicle-mounted structure 190 may comprise liftgate 180, door 185, ramp 186, step 187, and/or another vehicle-mounted structure configured to deploy, retract, pivot, extend, lower, raise, or otherwise move relative to truck 100. In some examples, method 350 is used while movable vehicle-mounted structure 190 remains deployed or otherwise positioned such that movement of truck 100 may cause movable vehicle-mounted structure 190 to sweep through or occupy one or more regions adjacent to truck 100. For example, FIGS. 4A and 4B are schematic top views of truck 100 backing up into a turn with deployed liftgate 180, in accordance with some examples. More generally, method 350 may be used to account for the effect of any deployed movable vehicle-mounted structure 190 on maneuvering, clearance, collision avoidance, and safe vehicle operation.

Method 350 may commence with block 360 by receiving a vehicle drive command at advanced driving controller unit 150 of truck 100 while movable vehicle-mounted structure 190 is deployed. In some examples, the vehicle drive command may comprise a direction of travel of truck 100 and a steering wheel angle. The vehicle drive command may further comprise one or more of a commanded speed, a transmission state, a gear selection, a wheel-speed value, a steering-rate value, a curvature indication, a trailer-related parameter, a braking input, a throttle input, or another input indicative of expected vehicle motion. In some examples, advanced driving controller unit 150 may receive the vehicle drive command directly from a driver input system, indirectly from one or more vehicle systems, and/or based on one or more derived vehicle-motion parameters.

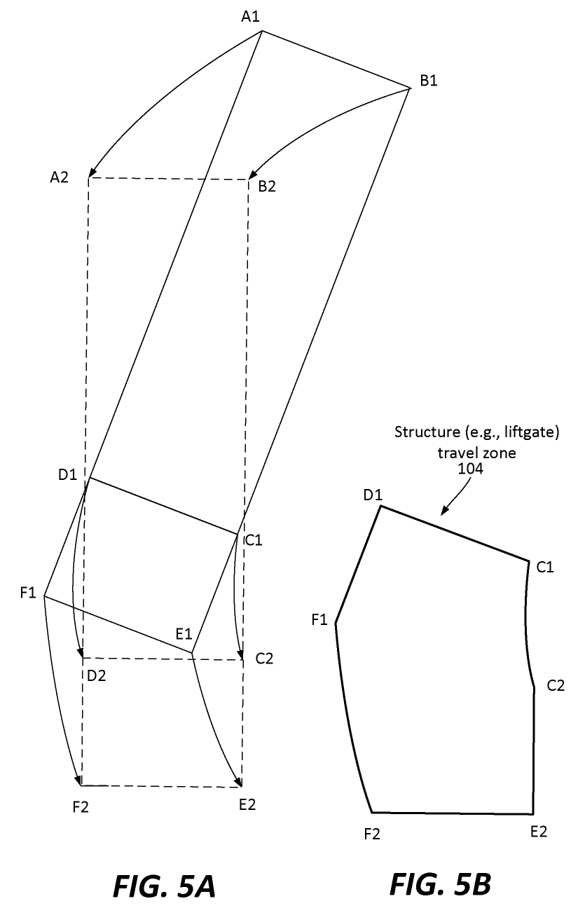

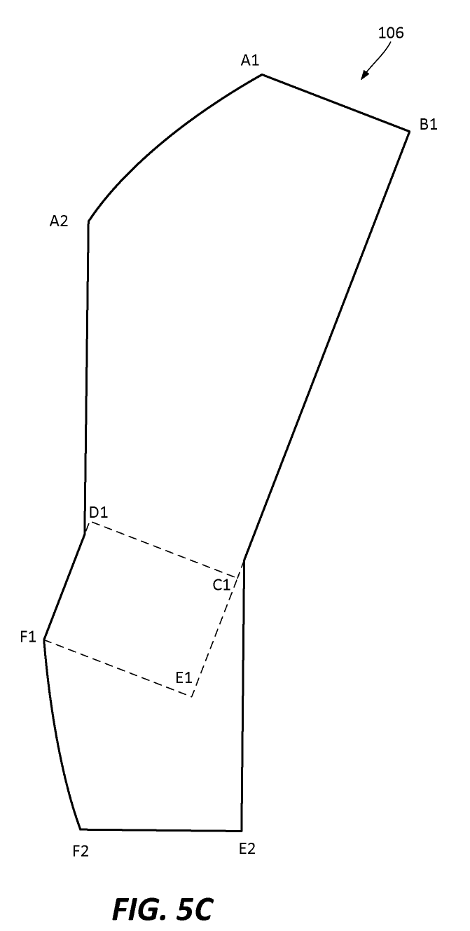

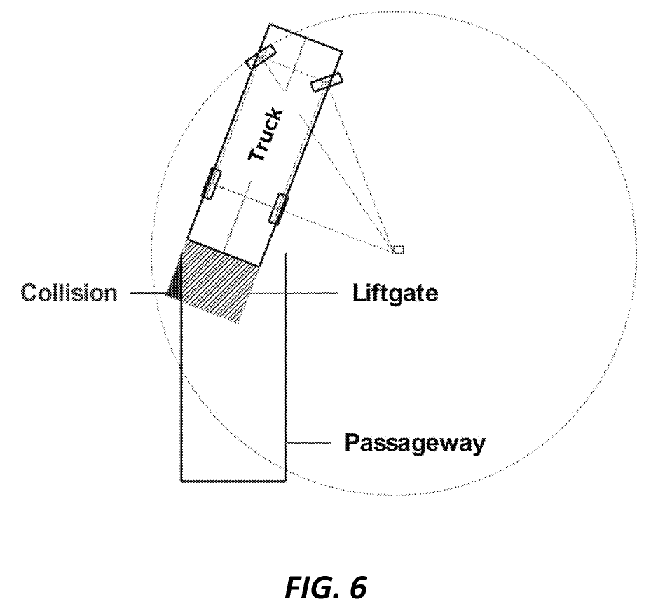

Method 350 proceeds with block 365 by determining a structure travel zone 104 based on the vehicle drive command. Structure travel zone 104 defines an expected trajectory, swept area, swept volume, clearance envelope, or other predicted region associated with movable vehicle-mounted structure 190 while truck 100 travels in accordance with the vehicle drive command, as schematically shown in FIGS. 5A-5C. In some examples, structure travel zone 104 is determined as a part of truck travel zone 106, which is defined as an expected trajectory or travel region of truck 100 while truck 100 travels in accordance with the vehicle drive command. Structure travel zone 104 may be based on one or more of the current vehicle pose, steering state, vehicle geometry, structure geometry, structure position, turning radius, predicted vehicle motion, predicted structure motion, and/or another parameter relevant to the movement of truck 100 and movable vehicle-mounted structure 190. It should be noted that structure travel zone 104 may be a subset, extension, or offset portion of overall truck travel zone 106. In some examples, when movable vehicle-mounted structure 190 is deployed, overall truck travel zone 106 and/or structure travel zone 104 may be greater than corresponding travel regions when movable vehicle-mounted structure 190 is stowed, which may require different maneuvering, turning, reversing, or docking behavior, as schematically shown in FIG. 6.

Method 350 proceeds with block 370 by obtaining spatial information corresponding to structure travel zone 104 using one or more vehicle sensors 140 of truck 100. In some examples, one or more vehicle sensors 140 are selected from one or more front cameras 152, one or more side cameras 154, one or more rear cameras 156, one or more LiDAR sensors 142, one or more radar sensors 144, one or more proximity sensors 146, and/or one or more other sensors 158. In some examples, the spatial information corresponding to structure travel zone 104 may comprise image data, video data, range information, depth information, point-cloud data, radar measurements, proximity measurements, fused multi-sensor information, and/or another sensor-derived representation of conditions in or around structure travel zone 104. Advanced driving controller unit 150 may select one or more sensors based on direction of travel, steering state, current structure position, expected maneuver, and/or another condition relevant to the predicted motion of truck 100 and movable vehicle-mounted structure 190.

In some examples, block 370 may involve obtaining spatial information from a single image, a temporal sequence of images, a video stream, one or more stereo image pairs, synchronized images from multiple viewpoints, one or more LiDAR scans, one or more radar scans, one or more proximity measurements, or any combination thereof. Advanced driving controller unit 150 may extract one or more image frames from a video stream, combine information over time, combine information across multiple viewpoints, and/or fuse image-derived information with LiDAR-derived, radar-derived, proximity-derived, or other sensor-derived information. Three-dimensional and/or depth-related information may be derived using stereo vision, monocular depth estimation, structure-from-motion, multi-view reconstruction, simultaneous localization and mapping (SLAM), point-cloud processing, range estimation, or another suitable technique.

In some examples, the spatial information obtained at block 370 may be calibrated, registered, and/or transformed prior to or as part of subsequent analysis. For example, one or more cameras or other sensors may be intrinsically calibrated and/or extrinsically calibrated relative to each other, relative to truck 100, and/or relative to movable vehicle-mounted structure 190. Such calibration may be preconfigured, dynamically updated during operation, and/or automatically estimated based on sensed data. In some examples, advanced driving controller unit 150 may transform image data, depth information, point clouds, detections, and/or other spatial information into a common coordinate frame, such as a vehicle-fixed coordinate system, a structure-fixed coordinate system, a ground-plane reference frame, or another common reference frame, to support more accurate spatial reasoning with respect to structure travel zone 104 and predicted movement of movable vehicle-mounted structure 190.

Method 350 proceeds with block 375 by analyzing the spatial information corresponding to structure travel zone 104 using advanced driving controller unit 150 to determine whether one or more travel criteria are satisfied. In some examples, one or more travel criteria are selected from or based on the absence of one or more objects in structure travel zone 104, lack of /limited occupancy detection in structure travel zone 104, free-space estimation for structure travel zone 104, collision risk assessment for structure travel zone 104, and/or intrusion detection with respect to structure travel zone 104. The analysis at block 375 may further include clearance determination, trajectory-based risk assessment, swept-area analysis, swept-volume analysis, motion prediction, path-interference analysis, and/or another spatial reasoning operation relevant to driving truck 100 with movable vehicle-mounted structure 190 deployed. Advanced driving controller unit 150 may determine whether structure travel zone 104 is sufficiently clear, whether a threshold amount of free space is available, whether a collision-risk value is below or above a threshold, whether an intrusion has occurred or is predicted, and/or whether another travel-permission condition is satisfied.

In some examples, the analysis at block 375 may be based on current sensor data, temporally accumulated sensor data, predicted motion of truck 100, predicted motion of movable vehicle-mounted structure 190, and/or a combination thereof. In some examples, the analysis may use one or more two-dimensional, depth-based, and/or three-dimensional representations of the environment adjacent to truck 100. Advanced driving controller unit 150 may compare the calibrated and transformed spatial information to a model, footprint, trajectory, swept area, swept volume, or clearance envelope of movable vehicle-mounted structure 190 during travel of truck 100. In some examples, such analysis may account for turning, reversing, backing into a loading area, entering a passageway, negotiating a corner, approaching a dock, or another maneuver in which the deployed movable vehicle-mounted structure 190 may create an expanded travel region or an increased collision risk.

If the spatial information does not satisfy one or more travel criteria at decision block 380, method 350 proceeds with block 385 by sending instructions to stop truck 100 and sending a warning to the driver of truck 100. In some examples, the stop instruction may be sent by the advanced driving controller unit 150 to the vehicle control unit 160 of the truck 100. The warning may be provided using driver user interface 172, warning unit 174, an audible output, a visual output, a haptic output, or another driver notification mechanism. Alternatively, if the spatial information satisfies one or more travel criteria, truck 100 may be allowed to proceed in accordance with the vehicle drive command, and method 350 may continue to monitor structure travel zone 104 during ongoing vehicle motion. In some examples, advanced driving controller unit 150 may issue other commands in addition to or instead of a full stop command, such as a slow-down command, a pause command, a steering-related restriction, a maneuver-inhibit command, or another vehicle-control action.

In some examples, liftgate 180 is one example of movable vehicle-mounted structure 190 such that the structure travel zone 104 may correspond to a liftgate travel zone associated with the expected motion of liftgate 180 while truck 100 is moving, such as while reversing into a turn or entering a confined passageway. The spatial information may comprise one or more images obtained using one or more cameras 151, and the advanced driving controller unit 150 may analyze the one or more images to determine whether one or more objects are present in the liftgate travel zone. As such, the broader method 350 described herein expressly encompasses a liftgate-specific implementation in which image-based analysis is used to control the driving of truck 100 while liftgate 180 is deployed.

In some examples, the operations of receiving the vehicle drive command, determining structure travel zone 104, obtaining the spatial information corresponding to structure travel zone 104, and analyzing the spatial information corresponding to structure travel zone 104 are performed continuouslySuch operations may be performed continuously, periodically, iteratively, frame-by-frame, sensor-update-by-sensor-update, event-driven, or otherwise repeatedly while truck 100 is moving or preparing to move with movable vehicle-mounted structure 190 deployed. In some examples, repeated analysis may allow the advanced driving controller unit 150 to update structure travel zone 104 in real time or near real time as the vehicle drive command changes, as vehicle position changes, as steering changes, as structure position changes, and/or as environmental conditions change. Method 350 may continue until truck 100 stops, until movable vehicle-mounted structure 190 is retracted or otherwise repositioned, until a maneuver is completed, or until another termination condition is satisfied.

### Conclusion

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A method for safely deploying a movable vehicle-mounted structure from a cabin of a truck without a direct line of sight of the movable vehicle-mounted structure, the method comprising:
receiving a structure deployment request at an advanced driving controller unit of the truck;
obtaining spatial information of a structure zone using one or more vehicle sensors, wherein:
the structure zone corresponds to a footprint of the movable vehicle-mounted structure in a deployed state, and
the spatial information of a structure zone is received by the advanced driving controller unit;
analyzing the spatial information of the structure zone to determine if the spatial information meets one or more criteria selected from the group consisting of (a) absence of any objects in the structure zone, (b) no occupancy detection in the structure zone, (c) free-space estimation of the structure zone, (d) collision risk assessment of the structure zone, and (e) no intrusion detection of the structure zone, wherein the spatial information is analyzed using the advanced driving controller unit; and
if the spatial information meets the one or more criteria, sending instructions to the movable vehicle-mounted structure to deploy the movable vehicle-mounted structure.

2. The method of claim 1, wherein the one or more vehicle sensors are selected from the group consisting of one or more front cameras, one or more side cameras, one or more rear cameras, a LiDAR, a radar, and a proximity sensor.

3. The method of claim 1, wherein the movable vehicle-mounted structure is selected from the group consisting of a liftgate, a ramp, a step, a door, a hatch, a platform, a carrier, a ladder, and an access panel.

4. The method of claim 1, further comprising, if the spatial information does not meet the one or more criteria, sending a warning to a driver of the truck.

5. The method of claim 1, further comprising repeating (i) obtaining the spatial information of the structure zone and (ii) analyzing the spatial information of the structure zone while the movable vehicle-mounted structure is being deployed.

6. The method of claim 1, wherein the structure deployment request is generated using a control switch positioned in the cabin of the truck.

7. The method of claim 6, wherein the control switch is a part of a driver user interface, further comprising a warning unit.

8. The method of claim 7, wherein the driver user interface is configured to display the spatial information of the structure zone.

9. The method of claim 1, further comprising, upon receiving the structure deployment request:
determining if the truck is immobilized, and
the spatial information of the structure zone is obtained only when the truck is immobilized.

10. The method of claim 9, further comprising immobilizing the truck in response to receiving the structure deployment request.

11. The method of claim 10, wherein immobilizing the truck comprises sending a request from the advanced driving controller unit to a vehicle control unit of the truck.

12. The method of claim 1, wherein the truck is one of a Class 2 truck, a Class 3 truck, a Class 4 truck, or a Class 5 truck.

13. The method of claim 1, wherein the spatial information comprises one or more of image data, video data, depth information, range information, point-cloud data, radar data, and proximity-sensor data.

14. The method of claim 1, wherein obtaining the spatial information comprises receiving data from a plurality of vehicle sensors and fusing the data at the advanced driving controller unit.

15. The method of claim 1, wherein obtaining the spatial information comprises obtaining a temporal sequence of images and analyzing changes over time in the structure zone.

16. The method of claim 1, wherein obtaining the spatial information comprises obtaining synchronized images from multiple viewpoints of the truck.

17. The method of claim 1, wherein the spatial information comprises three-dimensional or depth-related information derived using stereo vision, monocular depth estimation, structure-from-motion, multi-view reconstruction, simultaneous localization and mapping (SLAM), or a combination thereof.

18. The method of claim 1, wherein analyzing the spatial information comprises determining whether a threshold amount of free space is present within the structure zone.

19. The method of claim 1, wherein analyzing the spatial information comprises determining whether a collision-risk value associated with deployment of the movable vehicle-mounted structure is below a threshold.

20. The method of claim 1, wherein analyzing the spatial information comprises detecting intrusion of a person, animal, or object into the structure zone during deployment of the movable vehicle-mounted structure.
